(19) United States
(12) Patent Application Publication
(10) Pub. No.: US 2026/0017951 A1
(43) Pub. Date: Jan. 15, 2026

(54) DEVICE AND METHOD FOR DETECTING OBJECT AND VEHICLE SYSTEM HAVING THE SAME

(71) Applicants: Hyundai Motor Company, Seoul (KR); Kia Corporation, Seoul (KR); KOOKMIN UNIVERSITY INDUSTRY-ACADEMIC COOPERATION FOUNDATION, Seoul (KR)

(72) Inventors: Jang Ho SHIN, Hwaseong-Si (KR); Yong Seong LEE, Seoul (KR); Jong Chan KIM, Seoul (KR); Hong Suk KIM, Seoul (KR)

(73) Assignees: Hyundai Motor Company, Seoul (KR); Kia Corporation, Seoul (KR); KOOKMIN UNIVERSITY INDUSTRY-ACADEMIC COOPERATION FOUNDATION, Seoul (KR)

(21) Appl. No.: 19/047,332

(22) Filed: Feb. 6, 2025

(30) Foreign Application Priority Data
Jul. 10, 2024 (KR) 10-2024-0091334

(51) Int. Cl. G06V 20/58; G06V 10/82; G06V 10/94; G06V 20/52

(52) U.S. Cl. CPC G06V 20/58; G06V 10/82; G06V 10/955; G06V 20/52

(57) ABSTRACT

In a device for and a method of detecting an object and a vehicle system including the same, the device for detecting an object includes a processor, and a storage medium storing instructions executable by the processor. The processor is configured, by executing the instructions, to switch a plurality of computing nodes to a cluster mode, transmit image data from an image sensor to the plurality of computing nodes, generate a time stamp for a first frame included in the image data by one of the plurality of computing nodes, process the image data based on the time stamp by the plurality of computing nodes, and detect the object from the image data based on processing results of the plurality of computing nodes.

### CROSS-REFERENCE TO RELATED APPLICATION(S)

The present application claims priority to Korean Patent Application No. 10-2024-0091334 filed on Jul. 10, 2024, the entire contents of which is incorporated herein for all purposes by this reference.

### BACKGROUND OF THE PRESENT DISCLOSURE

### Field of the Present Disclosure

The present disclosure relates to a device for and a method of detecting an object and a vehicle system including the same.

### Description of Related Art

The safety system of a vehicle is directed to protect the driver or other passengers in the event of an accident. The vehicle is provided with safety devices such as airbags and/or pre-safe seat belts (PSBs) to protect passengers, and the safety system may activate the safety devices in the event of a collision.

To effectively prevent death or injury to passengers, it is necessary to appropriately activate the safety devices by considering not only information related to the vehicle situation but also passenger status information when an accident occurs.

To rapidly identify the condition of passengers in a dangerous situation, a technology is needed which may maximize or dynamically adjust a frame rate of processing image data monitoring the vehicle interior in certain situations.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a device for and a method of detecting an object and a vehicle system including the same, in which a frame rate of image processing may be improved, using cluster computing technology.

An aspect of the present disclosure is to provide a device for and a method of detecting an object and a vehicle system including the same, in which a frame rate may be maximized by switching a plurality of computing nodes to a cluster mode based on whether an emergency situation has occurred and processing image data by a plurality of computing nodes.

An aspect of the present disclosure is to provide a device for and a method of detecting an object and a vehicle system including the same, in which a transmission order between frames processed by a plurality of computing nodes may be prevented from being reversed.

According to various exemplary embodiments of the present disclosure, a device for and a method of detecting an object and a vehicle system including the same are provided.

According to an aspect of the present disclosure, a device for detecting an object includes a processor, and a storage medium storing instructions executable by the processor. The processor is configured, by executing the instructions, to switch a plurality of computing nodes to a cluster mode, transmit image data from an image sensor to the plurality of computing nodes, generate a time stamp for a first frame included in the image data by one of the plurality of computing nodes, process the image data based on the time stamp by the plurality of computing nodes, and detect the object from the image data based on processing results of the plurality of computing nodes.

According to an aspect of the present disclosure, a method of detecting an object performed in a computing device including a processor and a storage medium storing instructions executable by the processor, includes switching a plurality of computing nodes to a cluster mode, transmitting image data from an image sensor to the plurality of computing nodes, generating a time stamp for a first frame included in the image data by one of the plurality of computing nodes, processing the image data based on the time stamp by the plurality of computing nodes, and detecting the object from the image data based on processing results of the plurality of computing nodes.

According to an aspect of the present disclosure, a vehicle system includes one or more sensors including an image sensor, a plurality of computing nodes performing object detection processing on image data transmitted from the image sensor, a monitoring node collecting processing results of the plurality of computing nodes and generating monitoring information, and a vehicle controller configured for controlling a vehicle based on the monitoring information. A time stamp for a first frame included in the image data is generated by any one of the plurality of computing nodes, and the plurality of computing nodes process the image data based on the time stamp.

According to an aspect of the present disclosure, a device for detecting an object includes a processor, and a storage medium storing instructions executable by the processor. The processor is configured, by executing the instructions, to switch a plurality of computing nodes to a cluster mode, transmit image data from an image sensor to the plurality of computing nodes, perform data processing on a first frame included in the image data by a first computing node, one of the plurality of computing nodes, process image data between the first frame and a second frame, a next image processing target of the first computing node, by remaining computing nodes of the plurality of computing nodes excluding the first computing node, and detect the object from the image data based on processing results of the plurality of computing nodes.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF DRAWINGS

FIG. 1 schematically illustrates an object detection system for a vehicle according to an exemplary embodiment of the present disclosure.

FIG. 2 is a flowchart of a method of detecting an object according to an exemplary embodiment of the present disclosure.

FIG. 3 is a flowchart of a method of detecting an object according to an exemplary embodiment of the present disclosure.

FIG. 4 is a flowchart of a method of detecting an object according to an exemplary embodiment of the present disclosure.

FIG. 5 is an example drawing illustrating a method of detecting an object according to an exemplary embodiment of the present disclosure.

FIG. 6 is an example drawing illustrating a method of detecting an object according to an exemplary embodiment of the present disclosure.

FIG. 7 is an example drawing illustrating a method of detecting an object according to an exemplary embodiment of the present disclosure.

FIG. 8A illustrates a graph illustrating a frame rate according to the number of nodes of a plurality of computing nodes in a method of detecting an object according to an exemplary embodiment of the present disclosure.

FIG. 8B illustrates a graph illustrating a delay time according to the number of nodes of a plurality of computing nodes in a method of detecting an object according to an exemplary embodiment of the present disclosure.

FIG. 9 is a block diagram of a computing device which may fully or partially implement an object detection system for a vehicle according to an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Reference will now be made in detail to various embodiments of the present disclosure(s), examples of which are illustrated in the accompanying drawings and described below. While the present disclosure(s) will be described in conjunction with exemplary embodiments of the present disclosure, it will be understood that the present description is not intended to limit the present disclosure(s) to those exemplary embodiments of the present disclosure. On the other hand, the present disclosure(s) is/are intended to cover not only the exemplary embodiments of the present disclosure, but also various alternatives, modifications, equivalents and other embodiments, which may be included within the spirit and scope of the present disclosure as defined by the appended claims.

Hereinafter, detailed embodiments will be described with reference to the drawings. The detailed description below is provided to facilitate a comprehensive understanding of the methods, devices and/or systems described herein. However, this is only an example and the present disclosure is not limited thereto.

In describing embodiments, detailed descriptions of known technologies related to the present disclosure will be omitted if it is judged that such detailed descriptions may unnecessarily obscure the gist of the present disclosure. The terms described below are defined in consideration of the functions in the present disclosure, and may vary depending on the intention or custom of the user or operator. Therefore, the definition should be made based on the contents throughout this specification. The terminology used in the detailed description is only for describing embodiments and should not be limiting. Unless explicitly stated otherwise, expressions in the singular form include the meaning in the plural form. In this description, expressions such as “including” or “provided” are intended to indicate certain features, numbers, operations, operations, elements, parts or combinations thereof, and it should not be construed to exclude the existence or possibility of one or more other features, numbers, operations, operations, elements, or parts or combinations thereof, other than those described.

Furthermore, throughout the specification, when a part is said to be “connected” to another part, this includes not only cases where it is “directly connected” but also cases where it is “indirectly connected” with other elements therebetween.

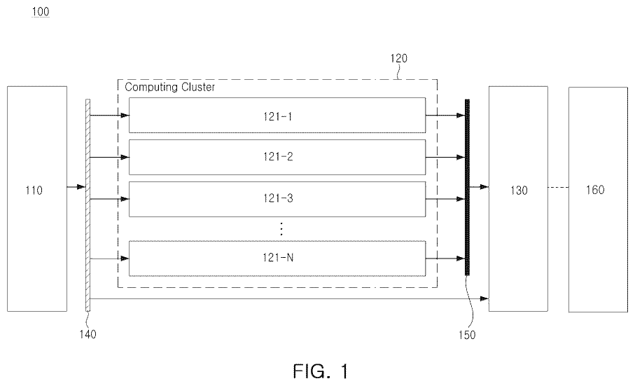

FIG. 1 schematically illustrates a vehicle system according to an exemplary embodiment of the present disclosure. Referring to FIG. 1, a vehicle system 100 may include an image sensor 110, a plurality of computing nodes 120, a monitoring node 130, a first communication network 140, and a second communication network 150. Each of the plurality of computing nodes 120 and the monitoring node 130 may include computing devices configured to transmit and receive data and perform computations within the vehicle system 100.

The vehicle system 100 may include a system provided inside or outside the vehicle, detecting an object from an image related to the vehicle and processing data. The vehicle system 100 may, for example, monitor the situation inside the vehicle and perform object detection processing using an artificial neural network model, from an image provided by capturing the interior of the vehicle, determining the position and posture of a driver or other passengers inside the vehicle and deriving information for executing a safety function of the vehicle.

The image sensor 110 may be provided at one or more locations inside the vehicle and may obtain image data inside the vehicle. The image sensor 110 may include at least one of a CCD (Charge-Coupled Device) sensor, a CMOS (Complementary Metal Oxide Semiconductor) sensor, a High Dynamic Range (HDR) image sensor, an Infrared (IR) image sensor, or a Multispectral image sensor. Image data obtained by the image sensor 110 may include a plurality of frames.

The plurality of computing nodes 120 may include, for example, N computing nodes. The plurality of computing nodes 120 may perform data processing for providing a vehicle's convenience function, or may process image data transmitted from the image sensor 110.

The plurality of computing nodes 120 may be set to distribute and process image data when switched to cluster mode. The plurality of computing nodes 120 may be switched to cluster mode, for example, when a dangerous situation is determined to have occurred.

For example, the plurality of computing nodes 120 may include a first computing node 121-1, a second computing node 121-2, and a third computing node 121-3.

The first computing node 121-1, the second computing node 121-2, and the third computing node 121-3 may be set to perform different functions when not in cluster mode.

The first computing node 121-1, the second computing node 121-2, and the third computing node 121-3 may perform distributed processing of image data when switched to cluster mode.

For example, in a non-cluster mode, the first computing node 121-1 performs in-cabin monitoring, the second computing node 121-2 performs monitoring for an Advanced Driver Assistance System (ADAS), and the third computing node 121-3 performs monitoring for providing infotainment. After the plurality of computing nodes 120 are switched to cluster mode, all of the first, second, and third computing nodes may be operated to perform in-cabin monitoring.

The monitoring node 130 may collect the processing results of image data transmitted from the plurality of computing nodes 120. The monitoring node 130 may integrate the object detection results by the plurality of respective computing nodes 120. The monitoring node 130 may detect an object from the image data based on the processing results of the plurality of computing nodes 120.

The monitoring node 130 may be configured to generate monitoring information. The monitoring information may include, for example, information related to the location, posture, and status of a driver or other passengers determined based on the integrated results of the object detection results by the plurality of computing nodes 120.

The vehicle system 100 may further include one or more other sensors and a vehicle controller 160.

One or more other sensors may be provided inside or outside the vehicle and may measure vehicle status information related to the driving situation of the vehicle. The one or more other sensors may further include at least one of, for example, a wheel speed sensor, a vehicle speed sensor configured for detecting the speed of the vehicle, an accelerator position sensor (APS) linked to the operation of the accelerator pedal, a brake pedal sensor (BPS) linked to the operation of the brake pedal, and a steering angle sensor (SAS) linked to the operation of the steering wheel. The vehicle status information may include at least one of wheel speed, vehicle speed, location information, acceleration status, deceleration status, accelerator pedal operation information, brake pedal operation information, steering wheel operation information, fuel level, and tire pressure.

The vehicle controller is configured to receive vehicle status information related to the driving situation of the vehicle from one or more other sensors. Furthermore, the vehicle controller is configured to receive monitoring information from the monitoring node 130.

The vehicle controller 160 may operate a safety control function based on at least one of the vehicle status information measured using one or more other sensors and the monitoring information received from the monitoring node 130. The vehicle controller 160 may be configured for controlling various components necessary for controlling the vehicle's starting, power, braking, steering, shifting and the like based on at least one of vehicle status information and monitoring information.

The first communication network 140 may include an Ethernet communication network. For example, image data obtained by the image sensor 110 may be transmitted from the image sensor 110 to at least one of the plurality of computing nodes 120 and the monitoring node 130 through the first communication network 140.

The second communication network 150 may include a CAN communication network 150. For example, the results of processing image data by the plurality of computing nodes 120 may be transmitted from the plurality of computing nodes 120 to the monitoring node 130 through the second communication network 150.

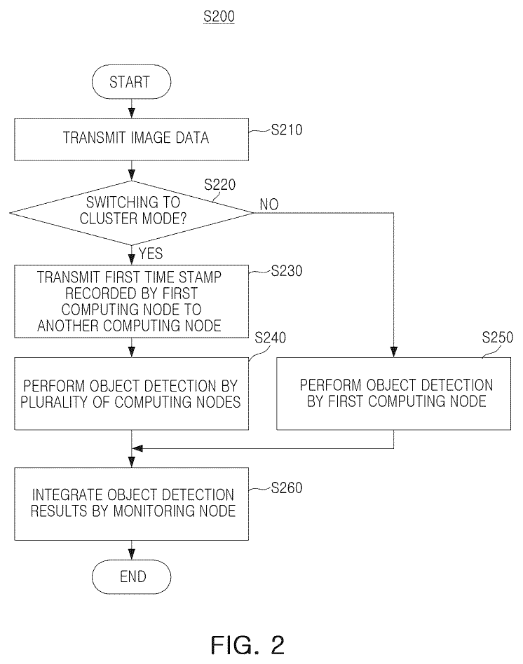

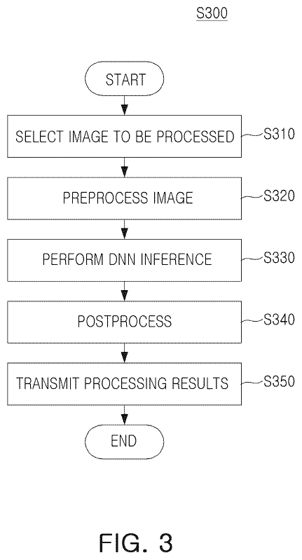

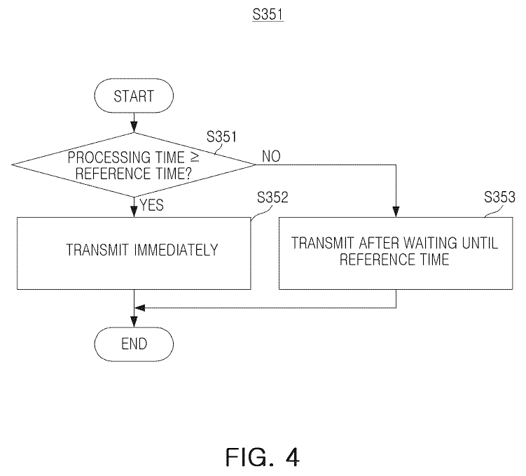

FIG. 2, FIG. 3 and FIG. 4 are flowcharts of a method of detecting an object according to an exemplary embodiment of the present disclosure. The method of detecting an object illustrated in FIG. 2, FIG. 3 and FIG. 4 may be performed in whole or in part by the vehicle system 100 illustrated in FIG. 1.

Referring to FIG. 2, a method (S200) of detecting an object may include an operation (S210) of transmitting image data from an image sensor to a plurality of computing nodes and an operation (S220) of determining whether the plurality of computing nodes are switched to a cluster mode.

In the operation (S210) of transmitting the image data, the image data may be transmitted from the image sensor to a plurality of computing nodes via an Ethernet communication network. The image data may also be transmitted from the image sensor to a monitoring node via an Ethernet communication network.

In the operation (S220) of determining whether switched to the cluster mode, whether a function requiring rapid object detection is executed may be determined based on measurement information of one or more sensors provided in the vehicle. The plurality of computing nodes may be switched to a cluster mode, for a function requiring rapid object detection.

For example, when a situation arises where it is difficult for a vehicle to avoid other vehicles, pedestrians, or obstacles while driving, a plurality of computing nodes may be switched to cluster mode and object detection may be performed rapidly.

The vehicle system may execute the Advanced Driver Assistance System (ADAS) emergency braking assistance function using the object detection results performed by the plurality of computing nodes switched to cluster mode. Furthermore, if it is determined that the vehicle may collide with another object, the plurality of computing nodes may be switched to cluster mode, and object detection may be performed on the image data for the interior of the vehicle to rapidly monitor and estimate the posture of the passenger inside the vehicle.

The vehicle system may be configured for controlling to deploy the passenger restraint device optimized for the posture of the passenger using the object detection results performed by the plurality of computing nodes switched to cluster mode. For example, the operation of the seat belt pretensioner operatively connected to the vehicle controller may be controlled by the vehicle controller, or whether the airbag operatively connected to the vehicle controller is activated or the time to fire of the airbag may be controlled by the vehicle controller according to the posture of the passenger estimated from the object detection results.

A first computing node, one of the plurality of computing nodes, may generate a first time stamp for the first frame included in the image data. The first frame may be, for example, the best frame in terms of time among multiple frames included in the image data.

In the operation (S220) of determining whether to switch to cluster mode, if it is determined that plurality of computing nodes have switched to cluster mode, the process may proceed to the operation (S230) of transmitting, by the vehicle controller, the first time stamp generated by the first computing node to another computing node and the operation (S240) of performing object detection by the plurality of computing nodes.

In the case in which the plurality of computing nodes have switched to cluster mode, in-cabin monitoring may be set to be performed by plurality of computing nodes. Therefore, the plurality of computing nodes, which are normally set to perform different functions, may be set to operate for in-cabin monitoring when necessary, significantly increasing a frame rate for processing images and effectively operating the vehicle's safety system.

In the operation (S230) of transmitting the first time stamp generated by the first computing node to another computing node, the first computing node may transmit the first time stamp to another computing node using network communication.

In the operation (S240) of performing object detection by the plurality of computing nodes, the plurality of computing nodes may derive processing target frames for respective nodes using a distributed consensus algorithm.

In the operation (S240) of performing object detection by the plurality of computing nodes, the plurality of computing nodes may process image data based on the first time stamp. For example, the plurality of computing nodes may derive a first processing target frame for each node from among the multiple frames included in the image data, based on the first time stamp.

In an exemplary embodiment of the present disclosure, the frame processing order may be set for the plurality of computing nodes. Deriving the first processing target frame for each node may be performed based on the first time stamp for the first frame, the frame processing order for each computing node, and the number of unit processing frames of the plurality of computing nodes.

The number of unit processing frames of the plurality of computing nodes may include a preset value. For example, if one computing node processes 5 frames per second and the number of nodes of the plurality of computing nodes is 6, the number of unit processing frames of the plurality of computing nodes may be set to 30.

The reciprocal of the number of unit processing frames of the plurality of computing nodes may refer to a cycle time. For example, when the number of unit processing frames of the plurality of computing nodes is 30, the cycle time may be 0.033333 (s).

The first processing target frame for each node may be derived, for example, using mathematical expression 1. In mathematical expression 1, the time stamp of the first processing target frame of the computing node in which the frame processing order is j is Tⱼ¹, the first time stamp for the first frame generated by the first computing node is T₁¹, and the number of unit processing frames of plurality of computing nodes may be F_{C}.

$${{T}_{j}}^{1} = {{T}_{1}}^{1} + \frac{j - 1}{{F}_{c}} \qquad [ Mathematical Expression 1 ]$$

In the operation (S240) of performing object detection by the plurality of computing nodes, the plurality of computing nodes may derive the next processing target frame for each node.

Deriving the next processing target frame for each node may be performed based on the previous processing target frame for each node, the number of nodes of the plurality of computing nodes, and the number of unit processing frames of the plurality of computing nodes.

The next processing target frame for each node may be derived, for example, using mathematical expression 2. In mathematical expression 2, the time stamp of the (k+1)th processing target frame of the computing node in which the frame processing order is j is Tⱼ^{k+1}, the time stamp of the kth processing target frame of the computing node in which the frame processing order is j is Tⱼ^{k}, the number of nodes of the plurality of computing nodes is N, and the number of unit processing frames of the plurality of computing nodes may be F_{C}.

$${{T}_{j}}^{k + 1} = {{T}_{j}}^{k} + \frac{N}{{F}_{C}} \qquad [ Mathematical Expression 2 ]$$

The interval between the time stamps of multiple frames included in the image data may have an error due to the performance of the image sensor. For example, if the image sensor provides 30 frames per second, the interval between frames should theoretically be 33.33 ms, but in reality, there may be a margin of 0.01 to 0.02 ms based on 33.33 ms.

Therefore, the plurality of computing nodes may additionally consider a margin range set in advance for the theoretical value of the time stamp derived using mathematical expression 1 or mathematical expression 2 when deriving the processing target frame for each node.

For example, if the time stamp of the mth processing target frame of the computing node in which the pre-set margin is e and the frame processing order is j is derived as Tⱼ^{m}, the processing target frame of the computing node may be predicted as a frame included in the range of

$$( {{T}_{j}}^{m} - e ) to ( {{T}_{j}}^{m} + e ) .$$

The plurality of computing nodes may select a frame in a round-robin manner from the derived time stamp range and perform object detection from the image of the selected frame.

For example, the plurality of computing nodes may check whether the time stamp is present within the prediction range derived from the time stamp of the processing target frame. If the time stamp is within the prediction range, object detection may be performed from the image of the frame. Furthermore, the range of the time stamp of the next processing target frame may be determined and updated.

Meanwhile, if the time stamp is smaller than the prediction range, object detection may be terminated immediately, without performing the object detection until the frame within the prediction range is transmitted. If the time stamp is greater than the predicted range, the time stamp of the next processing target frame may be re-predicted and updated.

Meanwhile, if it is determined that plurality of computing nodes have not been converted to cluster mode in the operation (S220) of determining whether to switch to cluster mode, the process may proceed to the operation (S250) of performing object detection by the first computing node.

If the plurality of computing nodes have not been converted to cluster mode, in-cabin monitoring may be performed by the first computing node, and other computing nodes may be set to perform other functions.

In the operation (S250) of performing object detection by the first computing node, the first computing node may sequentially process multiple frames included in the image data transmitted from the image sensor.

Following S240 or S250, the process may proceed to the operation (S260) of integrating the object detection results by the monitoring node.

In the operation (S260) of integrating the object detection results by the monitoring node, the monitoring node may collect the processing results of the image data transmitted from the plurality of computing nodes and integrate the object detection results by the plurality of respective computing nodes.

The monitoring node may detect the object from the image data based on the processing results of the plurality of computing nodes and generate monitoring information. The monitoring information may include, for example, information related to the location, posture, and status of the driver or other passengers in the vehicle.

FIG. 3 is a detailed flowchart of an image data processing method by one of a plurality of computing nodes, performed in the method (S200) of detecting an object. An image data processing method (S300) illustrated in FIG. 3 may be included in at least one of S240 or S250 of the method (S200) of detecting an object.

Referring to FIG. 3, the image data processing method (S300) may include an operation (S310) of selecting an image to be processed, an operation (S320) of preprocessing an image, an operation (S330) of inferring using a Deep Neural Network (DNN) model, an operation (S340) of postprocessing, and an operation (S350) of transmitting a processing result.

In the operation (S310) of selecting an image to be processed, a plurality of computing nodes may derive a time stamp of a frame to be processed for respective nodes using a distributed consensus algorithm.

For example, the operation (S310) of selecting an image to be processed may include an operation of deriving a frame to be processed from among multiple frames included in the image data using the above-described mathematical expression 1 or mathematical expression 2.

In the operation (S310) of selecting an image to be processed, a frame to be processed may be derived based on a time stamp of a frame to be processed derived using mathematical expression 1 or mathematical expression 2 and a pre-set margin range.

In the operation (S320) of preprocessing the image, the processing target frame may be preprocessed based on the input requirements of the DNN model. For example, the size of the processing target frame derived from S310 may be adjusted, or the quantization processing of the processing target frame may be performed.

In the operation (S330) of inferring using the DNN model, the processing target frame preprocessed in S310 is input to the DNN model, and the coordinate values of the object recognition and bounding box may be derived as the output result values.

In the operation (S340) of postprocessing, the output result value derived from S330 may be postprocessed and the final processing result may be generated. For example, an object recognized repeatedly in S330 may be removed through Non-maximum Suppression (NMS).

In the operation (S350) of transmitting the processing results, the processing results of the plurality of computing nodes may be transmitted to the monitoring node 130. In the operation (S350) of transmitting the processing results, the processing results may be transmitted to the monitoring node based on the processing times and reference times of the plurality of computing nodes, for respective nodes.

The reference time may include a preset value for the processing times of plurality of computing nodes. For example, the reference time may be set based on a maximum value of the expected processing time of the plurality of computing nodes.

FIG. 4 is a detailed flowchart of the operation (S350) of transmitting processing results included in the image data processing method (S300) illustrated in FIG. 3.

Referring to FIG. 4, in S351, the length of the processing time of one computing node and the length of the reference time are compared, and if the processing time of one computing node is the reference time or more, the process may proceed to the operation (S352) of transmitting the processing result immediately.

Meanwhile, if the processing time of one computing node is less than the reference time in S351, the process may proceed to the operation (S353) of transmitting the processing result after waiting until the reference time. For example, if the processing time of one computing node is less than the reference time, the computing node may be set to execute a busy loop until the reference time.

In an exemplary embodiment of the present disclosure, the concept of Logical Execution Time (LET) is applied to prevent the order of frames transmitted from the monitoring node from being reversed due to deviations in the processing times of respective nodes of the plurality of computing nodes. For example, the worst case execution time (WCET) of the plurality of computing nodes may be measured and set as the reference time. By considering the reference time when transmitting the processing results from respective computing nodes to the monitoring node, the problem of the transmission order being reversed between multiple frames may be resolved.

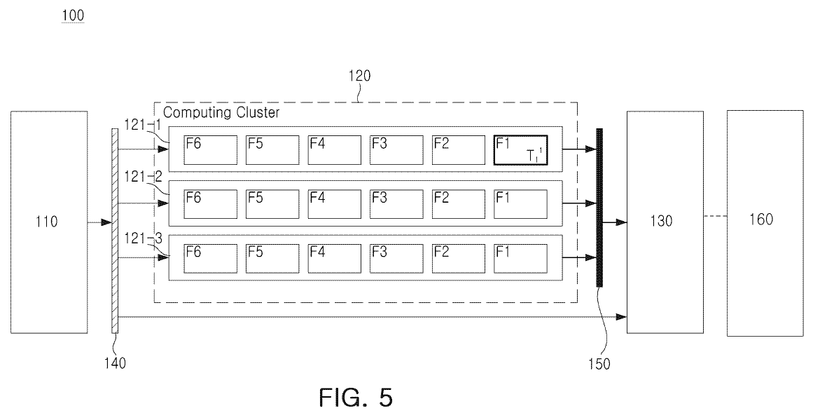

FIGS. 5, 6 and 7 are example drawings illustrating a method of detecting an object according to an exemplary embodiment of the present disclosure.

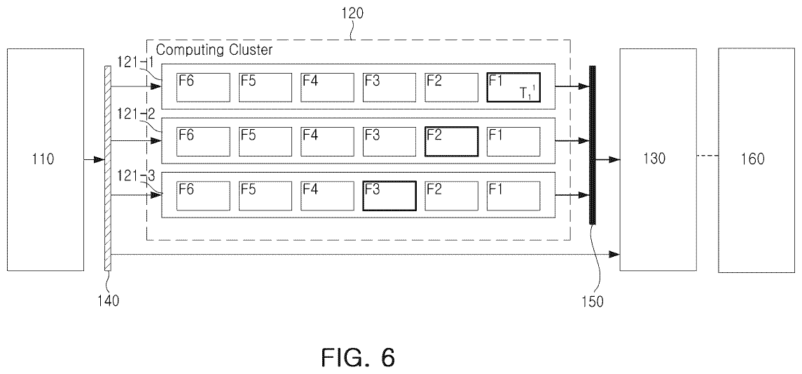

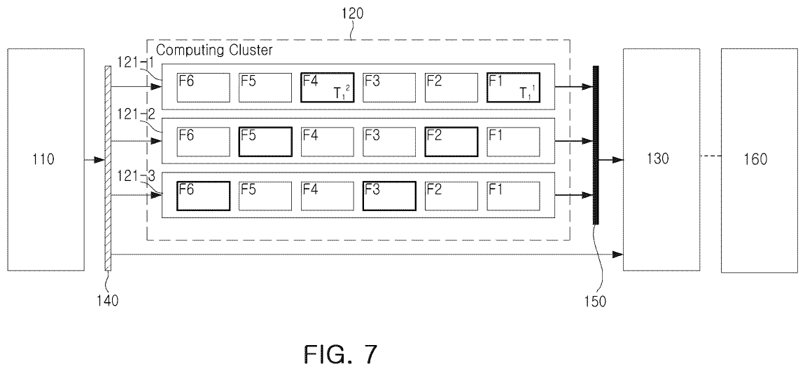

Referring to FIG. 5, FIG. 6 and FIG. 7, a vehicle system 100 in which a method of detecting an object according to an exemplary embodiment of the present disclosure is performed includes an image sensor 110, a plurality of computing nodes 120, a monitoring node 130, a first communication network 140, and a second communication network 150, and the plurality of computing nodes 120 may include a first computing node 121-1, a second computing node 121-2 and a third computing node 121-3.

Image data transmitted from the image sensor 110 to the plurality of computing nodes 120 may include multiple frames F1 to F6.

Referring to FIG. 5, one of the plurality of computing nodes 120, the first computing node 121-1, may be configured to generate a first time stamp T₁¹ for the first frame F1 included in the image data.

When the plurality of computing nodes 120 are switched to cluster mode, the first computing node 121-1 may transmit the first time stamp T₁¹ for the first frame F1 to another computing node. The computing node may derive the first processing target frame for each node based on the first time stamp T₁¹ for the first frame F1.

As illustrated in FIG. 6, the second computing node 121-2 may derive the first processing target frame F2 based on the first time stamp T₁¹ for the first frame F1, the frame processing order, and the number of unit processing frames of the plurality of computing nodes 120. Furthermore, the third computing node 121-3 may derive the first processing target frame F3 based on the first time stamp T₁¹ for the first frame F1, the frame processing order, and the number of unit processing frames of the plurality of computing nodes 120.

For example, the second computing node 121-2 and the third computing node 121-3 may derive the time stamp of the first processing target frame for each node using the mathematical expression 1 described above.

The plurality of computing nodes 120 may derive the next processing target frame for each node based on the previous processing target frame for each node, the number of nodes of the plurality of computing nodes 120, and the number of unit processing frames of the plurality of computing nodes 120.

As illustrated in FIG. 7, the first computing node 121-1 may derive the next processing target frame F4 of the first computing node 121-1 based on the previous processing target frame F1, the number, for example, three, of nodes of the plurality of computing nodes 120, and the number of unit processing frames of the plurality of computing nodes 120.

Furthermore, the second computing node 121-2 may derive the next processing target frame F5 of the second computing node 121-2 based on the previous processing target frame F2, the number, for example, three, of nodes of the plurality of computing nodes 120, and the number of unit processing frames of the plurality of computing nodes 120. Furthermore, the third computing node 121-3 may derive the next processing target frame F6 of the third computing node 121-3 based on the previous processing target frame F3, the number, for example, three, of nodes of the plurality of computing nodes 120, and the number of unit processing frames of the plurality of computing nodes 120.

For example, the first computing node 121-1, the second computing node 121-2, and the third computing node 121-3 may derive the time stamp of the next processing target frame for each node using the mathematical expression 2 described above.

As described above, the frames F2 and F3 between the first frame F1, which is the first processing target frame of the first computing node 121-1, and the next processing target frame F4 of the first computing node 121-1 may be processed by either the second computing node 121-2 or the third computing node 121-3.

The second computing node 121-2 and the third computing node 121-3 may sequentially process frames F2 and F3 in a predetermined order.

For example, the remaining computing nodes, excluding the first computing node among the plurality of computing nodes, may process image data between two frames processed by the first computing node.

Furthermore, after the first computing node 121-1 processes the first frame F1, the second computing node 121-2 processes the second frame F2 and the third computing node 121-3 processes the third frame F3, the plurality of computing nodes may transmit the data processing results to the monitoring node.

For example, when the plurality of computing nodes all complete one round of image data processing, the data processing results may be transmitted to the monitoring node at once.

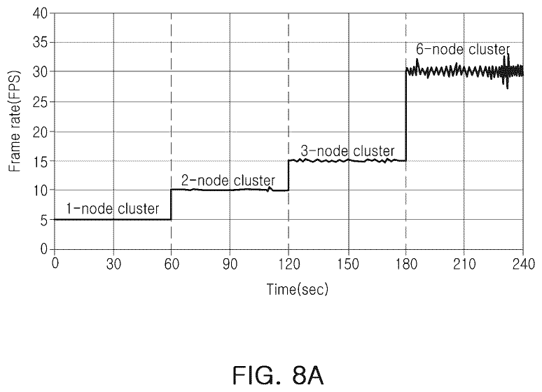

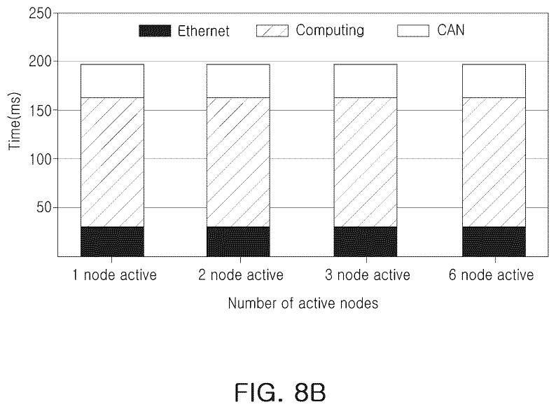

FIG. 8A illustrates an example of a frame rate according to the number of nodes of the plurality of computing nodes in the method of detecting an object according to an exemplary embodiment of the present disclosure. As illustrated in FIG. 8A, it may be confirmed that the frame rate linearly increases in proportion to the number of nodes of the plurality of computing nodes.

FIG. 8B illustrates an example of a delay time according to the number of nodes of the plurality of computing nodes in the method of detecting an object according to an exemplary embodiment of the present disclosure. As illustrated in FIG. 8B, it may be confirmed that the end-to-end delay time from acquisition of image data to output of results remains the same even when the number of nodes of the plurality of computing nodes increases.

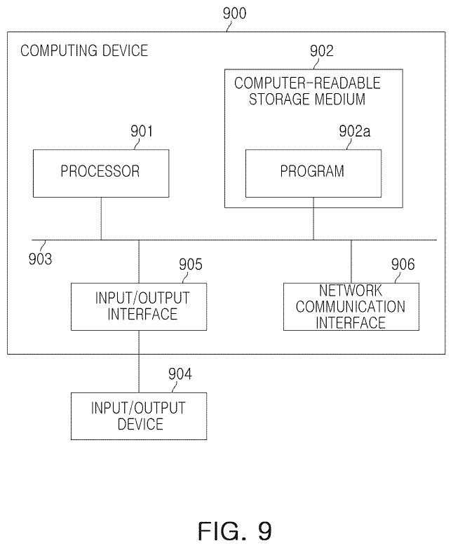

FIG. 9 is a block diagram of a computing device 900 which may fully or partially implement a vehicle system according to an exemplary embodiment of the present disclosure, and may include all or portion of the vehicle system 100 illustrated in FIG. 1.

As illustrated in FIG. 9, the computing device 900 includes at least one processor 901, a computer-readable storage medium 902, and a communication bus 903.

The processor 901 may enable the computing device 900 to operate according to the above-mentioned example embodiments. For example, the processor 901 may execute one or more programs stored in the computer-readable storage medium 902. The one or more programs may include one or more computer executable instructions, and the computer-executable instructions may be configured to enable the computing device 900 to execute operations according to exemplary embodiments of the present disclosure, when executed by the processor 901.

The computer-readable storage medium 902 is configured to store computer-executable instructions or program code, program data, and/or other suitable forms of information. The program 902a stored in the computer-readable storage medium 902 includes a set of instructions executable by the processor 901. In an exemplary embodiment of the present disclosure, the computer-readable storage medium 902 may be a memory (a volatile memory, such as random access memory, a non-volatile memory, or an appropriate combination thereof), one or more magnetic disk storage devices, optical disk storage devices, flash memory devices, other types of storage media which may be accessed by the computing device 900 and store required information, or a suitable combination thereof.

The communication bus 903 interconnects various other components of computing device 900, including processor 901 and computer-readable storage medium 902.

The computing device 900 may also include one or more input/output interfaces 905 and one or more network communication interfaces 906 that provide an interface for one or more input/output devices 904. The input/output interface 905 and the network communication interface 906 are connected to the communication bus 903.

The network communication interface 906 is an interface for communication within the vehicle or an interface for communication between the vehicle and other devices outside the vehicle, and may include, for example, a Controller Area Network (CAN), a Media Oriented Systems Transport (MOST) network, a Local Interconnect Network (LIN), and/or X-by-Wire (Flexray), Wi-Fi, Bluetooth, NFC, RFID, or the like. The network may be any one of cellular networks such as Global System for Mobile Communications (GSM), Enhanced Data Rates for GSM Evolution (EDGE), General Packet Radio Service (GPRS), Code Division Multiple Access (CDMA), Time Division-CDMA (TD-CDMA), Universal Mobile Telecommunications System (UMTS), Long Term Evolution (LTE), or other cellular networks.

The input/output device 904 may be connected to other components of the computing device 900 through the input/output interface 905. Examples of the input/output device 904 may include a pointing device (such as a mouse or trackpad), keyboard, touch input device (such as a touchpad or touchscreen), or voice or sound input device, input devices such as various types of sensor devices and/or imaging devices, and/or output devices such as display devices, printers, speakers, and/or network cards. The illustrative input/output device 904 may be included within the computing device 900 as a component forming the computing device 900, or may be connected to the computing device 900 as a separate device distinct from the computing device 900.

Meanwhile, in embodiments of the present disclosure, a program for performing the methods described in the present specification on a computer, and a computer-readable recording medium containing the program, may be included. The computer-readable recording medium may include program instructions, local data files, local data structures, and the like, singly or in combination. The media may be those specifically designed and constructed for the present disclosure, or may be those commonly available in the computer software field. Examples of computer-readable recording media may include magnetic media such as hard disks, floppy disks, and magnetic tapes, optical recording media such as CD-ROM and DVD, a specially configured hardware device to store and perform program instructions, such as ROM, RAM, flash memory, and the like. Examples of the programs may include not only machine language code such as that produced by a compiler, but also high-level language code which may be executed by a computer using an interpreter or the like.

As set forth above, according to an exemplary embodiment of the present disclosure, a device for and a method of detecting an object and a vehicle system including the same, in which a frame rate of image processing may be improved by use of cluster computing technology, may be provided.

In an exemplary embodiment of the present disclosure, there may be provided a device for and a method of detecting an object and a vehicle system including the same, in which a frame rate may be maximized by switching a plurality of computing nodes to a cluster mode and processing image data by a plurality of computing nodes.

In an exemplary embodiment of the present disclosure, there may be provided a device for and a method of detecting an object and a vehicle system including the same, in which a transmission order between frames processed by a plurality of computing nodes may be prevented from being reversed.

The control device may be at least one microprocessor operated by a predetermined program which may include a series of commands for carrying out the method included in the aforementioned various exemplary embodiments of the present disclosure.

In various exemplary embodiments of the present disclosure, each operation described above may be performed by a control device, and the control device may be configured by multiple control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well known to a person having ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, multiple operations may be merged, or any operation may be divided, and a predetermined operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. An apparatus for detecting an object, the apparatus comprising:
a processor; and
a storage medium storing instructions executable by the processor,
wherein the processor is configured, by executing the instructions, to switch a plurality of computing nodes to a cluster mode, transmit image data from an image sensor to the plurality of computing nodes, generate a time stamp for a first frame included in the image data by one of the plurality of computing nodes, process the image data based on the time stamp by the plurality of computing nodes, and detect the object from the image data based on processing results of the plurality of computing nodes.

2. The apparatus of claim 1, wherein the processor is further configured to transmit the time stamp for the first frame from one of the plurality of computing nodes to another computing node of the plurality of computing nodes, and to derive a first processing target frame for each node from the image data based on the time stamp for the first frame, by the another computing node.

3. The apparatus of claim 2, wherein the processor is further configured to set a frame processing order for the plurality of computing nodes, and to derive the first processing target frame for each node by the another computing node, based on the time stamp for the first frame, a frame processing order for each computing node, and a number of unit processing frames of the plurality of computing nodes.

4. The apparatus of claim 2, wherein the processor is further configured to derive a next processing target frame for each node based on a previous processing target frame for each node, a number of nodes of the plurality of computing nodes, and a number of unit processing frames of the plurality of computing nodes, by the plurality of computing nodes.

5. The apparatus of claim 1, wherein the processor is further configured to transmit the processing results from the plurality of computing nodes to a monitoring node, and to detect the object from the image data by the monitoring node.

6. The apparatus of claim 5, wherein the processor is further configured to set a reference time for processing times of the plurality of computing nodes, and to transmit the processing results of the image data to the monitoring node based on processing times of respective nodes of the plurality of computing nodes and the reference time.

7. The apparatus of claim 6, wherein the processor is further configured to set the reference time based on a maximum value of expected processing times of the plurality of computing nodes, and to transmit the processing results of the image data to the monitoring node after waiting until the reference time when the processing times of respective nodes are less than the reference time.

8. The apparatus of claim 1,
wherein the plurality of computing nodes perform different functions when not in the cluster mode, and
wherein the processor is further configured to determine whether to execute a function requiring rapid object detection based on measurement information of one or more sensors provided in a vehicle, and to switch the plurality of computing nodes to the cluster mode for the function requiring the rapid object detection.

9. A method of detecting an object performed in a computing device including a processor and a storage medium storing instructions executable by the processor, the method comprising:
switching, by the processor, a plurality of computing nodes to a cluster mode;
transmitting, by the processor, image data from an image sensor to the plurality of computing nodes;
generating, by the processor, a time stamp for a first frame included in the image data by one of the plurality of computing nodes;
processing, by the processor, the image data based on the time stamp by the plurality of computing nodes; and
detecting, by the processor, the object from the image data based on processing results of the plurality of computing nodes.

10. The method of claim 9, further including:
transmitting, by the processor, the time stamp for the first frame from one of the plurality of computing nodes to another computing node of the plurality of computing nodes; and
deriving, by the processor, a first processing target frame for each node from the image data based on the time stamp for the first frame, by the another computing node.

11. The method of claim 10, further including:
setting a frame processing order for the plurality of computing nodes,
wherein the deriving of the first processing target frame for each node includes deriving the first processing target frame for each node based on the time stamp for the first frame, a frame processing order for each computing node, and a number of unit processing frames of the plurality of computing nodes.

12. The method of claim 10, further including deriving a next processing target frame for each node based on a previous processing target frame for each node, a number of nodes of the plurality of computing nodes, and a number of unit processing frames of the plurality of computing nodes, by the plurality of computing nodes.

13. The method of claim 9, further including:
transmitting the processing results from the plurality of computing nodes to a monitoring node,
wherein the detecting of the object from the image data includes detecting the object from the image data by the monitoring node.

14. The method of claim 13, further including:
setting a reference time for processing times of the plurality of computing nodes,
wherein the transmitting of the processing results to the monitoring node includes transmitting the processing results of the image data to the monitoring node based on processing times of respective nodes of the plurality of computing nodes and the reference time.

15. The method of claim 14,
wherein the setting of the reference time of the plurality of computing nodes includes setting the reference time based on a maximum value of expected processing times of the plurality of computing nodes, and
wherein the transmitting of the processing results to the monitoring node includes determining whether the processing times of respective nodes are greater than or equal to the reference time, and transmitting the processing results of the image data to the monitoring node after waiting until the reference time when the processing times for respective nodes are less than the reference time.

16. The method of claim 9,
wherein the plurality of computing nodes perform different functions when not in the cluster mode, and
wherein the processor is further configured to determine whether a function requiring rapid object detection is to be executed based on measurement information from one or more sensors provided in a vehicle, and to switch the plurality of computing nodes to the cluster mode for the function requiring the rapid object detection.

17. A vehicle system comprising:
one or more sensors including an image sensor;
a plurality of computing nodes performing object detection processing on image data transmitted from the image sensor in a cluster mode;
a monitoring node collecting processing results of the plurality of computing nodes and generating monitoring information; and
a vehicle controller configured for controlling a vehicle based on the monitoring information,
wherein a time stamp for a first frame included in the image data is generated by any one of the plurality of computing nodes, and the plurality of computing nodes process the image data based on the time stamp.

18. The vehicle system of claim 17,
wherein one of the plurality of computing nodes transmits the time stamp for the first frame to another computing node among the plurality of computing nodes, and
wherein the another computing node derives a first processing target frame for each node from the image data based on the time stamp for the first frame.

19. The vehicle system of claim 17,
wherein the processing results of the image data is transmitted from the plurality of computing nodes to the monitoring node based on processing times for respective nodes of the plurality of computing nodes and a predetermined reference time, and
wherein the reference time is set based on a maximum value of expected processing times of the plurality of computing nodes.

20. The vehicle system of claim 17,
wherein the plurality of computing nodes perform different functions when not in the cluster mode, and
wherein the plurality of computing nodes are switched to the cluster mode for a function requiring rapid object detection by determining whether to execute the function requiring the rapid object detection based on measurement information of the one or more sensors.

21. A device for detecting an object, comprising:
a processor; and
a storage medium storing instructions executable by the processor,
wherein the processor is configured, by executing the instructions, to switch a plurality of computing nodes to a cluster mode, transmit image data from an image sensor to the plurality of computing nodes, perform data processing on a first frame included in the image data by a first computing node, one of the plurality of computing nodes, process image data between the first frame and a second frame, a next image processing target of the first computing node, by remaining computing nodes of the plurality of computing nodes excluding the first computing node, and detect the object from the image data based on processing results of the plurality of computing nodes.

22. The apparatus of claim 21, wherein the processor is configured to sequentially process image data between the first frame and the second frame in a predetermined order by remaining computing nodes excluding the first computing node among the plurality of computing nodes, to transmit data processing results to a monitoring node at once when all of the plurality of computing nodes complete one round of image data processing, and to detect the object from the image data by the monitoring node.
